(19) United States
(12) Patent Application Publication
(10) Pub. No.: US 2013/0029709 A1
(43) Pub. Date: Jan. 31, 2013

(54) PORTABLE TERMINAL, WIRELESS COMMUNICATION SYSTEM, AND WIRELESS COMMUNICATION METHOD

(71) Applicant: Hidetaka Hayashi, Kanagawa (JP)

(72) Inventor: Hidetaka Hayashi, Kanagawa (JP)

(73) Assignee: KYOCERA CORPORATION, Kyoto (JP)

(21) Appl. No.: 13/637,124

(22) PCT Filed: Mar. 25, 2011
(86) PCT No.: PCT/JP2011/057457

§ 371 Date: Sep. 25, 2012

(30) Foreign Application Priority Data
Mar. 26, 2010 (JP) 2010-073759

(51) Int. Cl. H04W 72/04

(52) U.S. Cl. 455/509

(57) ABSTRACT

A PHS terminal includes a communication unit that communicates wirelessly with a base station capable of adaptive array transmission and receives a CCH signal transmitted from the base station in a first time interval, a timing unit that measures the elapsed time since receiving, in the CCH, a BCCH transmitted from the base station in a second time interval, and a control unit that, in cases in which an LCH is established with the base station, transmits an LCH establishment request signal to the base station after the CCH signal has been received and receives, in the CCH, an LCH assignment signal transmitted from the base station, wherein the control unit controls the transmission timing of the LCH establishment request signal, such that the transmission timing of the next BCCH from the base station does not coincide with the transmission timing of the LCH assignment signal.

### TECHNICAL FIELD

The present invention relates to a portable terminal, a wireless communication system, and a wireless communications method, all of which are for wirelessly communicating with a base station employing an adaptive array scheme capable of controlling directional characteristics of radio waves to be transmitted toward a particular direction.

### BACKGROUND ART

Conventionally, in a wireless communication system including a base station and a portable terminal, when the portable terminal transmits a request signal for a link channel (LCH) to the base station, the base station receives the request signal, and transmits an assignment signal for the link channel, thereby establishing the link channel between the base station and the portable terminal.

When the base station transmits a signal to the portable terminal, the success rate in communication can be improved by giving directional characteristics to radio waves to be transmitted using an adaptive array antenna technology (for example, see Patent Document 1).

Patent Document 1: Japanese Unexamined Patent Application, Publication No. 2005-341170

### DISCLOSURE OF THE INVENTION

### Problems to be Solved by the Invention

The assignment signal for the link channel is one of signals included in a control channel (CCH) transmitted in a predetermined cycle (100 msec). In the control channel, the base station transmits a broadcasting signal (BCCH: Broadcast Control Channel) at a constant time interval (1200 msec), and the broadcasting signal is given priority over the assignment signal. In other words, when the timing of transmitting the broadcasting signal overlaps with the timing of transmitting the assignment signal, transmission of the assignment signal will be delayed until the next timing of transmitting the control channel (100 msec later).

Since the portable terminal that transmitted the request signal may have already moved in some cases, the success rate in receiving the assignment signal might be deteriorated when directional characteristics are given to radio waves transmitted from the base station by an adaptive array antenna. If the base station stops the adaptive array transmission, the intensity of the radio waves received by the portable terminal will be weakened, and the success rate in reception will be deteriorated as well.

An object of the present invention is to provide a portable terminal, a wireless communication system, and a wireless communication method, all of which can improve the success rate in receiving an assignment signal for a link channel.

### Means for Solving the Problems

The portable terminal according to the present invention includes: a communication unit that wirelessly communicates with a base station capable of controlling directional characteristics of radio waves to be transmitted toward a particular direction, and receives a signal in a control channel transmitted from the base station at a first time interval; a timing unit that measures a time period elapsed since receiving a broadcasting signal transmitted from the base station in the control channel at a second time interval; and a control unit, and in a case in which a link channel is established with the base station, after the communication unit receives a signal in the control channel, the control unit causes the communication unit to transmit a request signal to the base station, and causes the communication unit to receive an assignment signal for assigning the link channel in the control channel, the assignment signal being transmitted from the base station in response to the request signal, and the control unit controls timing of transmitting the request signal, such that timing of transmitting a next broadcasting signal by the base station does not coincide with timing of transmitting an assignment signal.

It is preferable for the control unit to refer to the time period elapsed thus measured by the timing unit, and in a case in which the timing of transmitting the request signal is immediately before the timing of transmitting the next broadcasting signal by the base station, it is preferable for the control unit to transmit the request signal with delay.

It is preferable for the control unit to transmit the request signal with delay of the first time interval.

It is preferable for the control unit to transmit the request signal after a third time interval has elapsed since receiving the next broadcasting signal.

It is preferable for the assignment signal to be a signal, of which priority of transmitting is lower than priority of transmitting the broadcasting signal.

The wireless communication system according to the present invention is a wireless communication system, in which a portable terminal wirelessly communicates with a base station capable of controlling directional characteristic of radio waves to be transmitted toward a particular direction, the base station includes: a base station communication unit that transmits a signal in a control channel at a first time interval, and transmits a broadcasting signal in the control channel at a second time interval; and a base station control unit, and in a case in which a request signal for establishing a link channel is received from the portable terminal, the base station control unit directs directional characteristics of radio waves to be transmitted toward a direction in which the request signal is received, and causes the base station communication unit to transmit an assignment signal for assigning the link channel, to the portable terminal in the control channel at timing different from timing of transmitting the broadcasting signal, and the portable terminal includes: a terminal communication unit that receives a signal in the control channel; a timing unit that measures a time period elapsed since receiving the broadcasting signal; and a terminal control unit, and in a case in which the link channel is established with the base station, the terminal control unit causes the terminal communication unit to transmit the request signal to the base station after a third time period has elapsed since receiving a signal in the control channel, and causes the terminal communication unit to receive the assignment signal in the control channel transmitted from the base station, and the terminal control unit refers to the time period elapsed thus measured by the timing unit, and controls timing of transmitting the request signal, such that timing of transmitting a next broadcasting signal by the base station does not coincide with the timing of transmitting the assignment signal.

The wireless communication method according to the present invention is a wireless communication method, in which a base station wirelessly communicates with a portable terminal, the base station is capable of controlling directional characteristic of radio waves to be transmitted toward a particular direction, the base station includes a base station communication unit that transmits a signal in a control channel at a first time interval, and transmits a broadcasting signal in the control channel at a second time interval, the portable terminal includes a terminal communication unit that receives a signal in the control channel, in which the method includes: a requesting step for the terminal communication unit to transmit a request signal to the base station after a third time period has elapsed since receiving a signal in the control channel, in a case in which the portable terminal establishes a link channel with the base station; and an assigning step for the base station to direct directional characteristics of radio waves to be transmitted toward a direction in which the request signal is received, and to cause the base station communication unit to transmit an assignment signal for assigning the link channel, to the portable terminal in the control channel at timing different from timing of transmitting the broadcasting signal, in a case in which the base station receives the request signal, and in the requesting step, the portable terminal refers to the time period elapsed measured in a timing step, and controls timing of transmitting the request signal, such that timing of transmitting a next broadcasting signal by the base station does not coincide with the timing of transmitting the assignment signal.

### Effects of the Invention

According to the present invention, the success rate in receiving an assignment signal for a link channel by a portable terminal can be improved.

### BRIEF DESCRIPTION OF THE DRAWINGS

FIG. 1 is a perspective view showing an appearance of a PHS terminal according to an embodiment of the present invention;

FIG. 2 is a block diagram showing functions of a wireless communication system according to the embodiment of the present invention;

FIG. 3 is a conceptual diagram showing a reception area of radio waves transmitted from an antenna according to the embodiment of the present invention;

FIG. 4 is a sequence chart showing a first processing pattern of the wireless communication system according to the embodiment of the present invention;

FIG. 5 is a sequence chart showing a second processing pattern of the wireless communication system according to the embodiment of the present invention;

FIG. 6 is a sequence chart showing a third processing pattern of the wireless communication system according to the embodiment of the present invention;

FIG. 7 is a flowchart showing processing until starting a watchdog timer in the PHS terminal according to the embodiment of the present invention;

FIG. 8 is a flowchart showing processing of establishing LCH in response to an outgoing call event, in the PHS terminal according to the embodiment of the present invention;

FIG. 9 is a diagram showing a relationship between a distance from a base station according to the embodiment of the present invention and field intensity of receiving an LCH assignment signal by the PHS terminal; and

FIG. 10 is a diagram showing a relationship between the distance from the base station according to the embodiment of the present invention and error rates in receiving an LCH assignment signal in the PHS terminal.

### PREFERRED MODE FOR CARRYING OUT THE INVENTION

Descriptions are hereinafter provided for an example of an embodiment of the present invention. In the present embodiment, a PHS (Personal Handyphone System; registered trademark) terminal 1 is described as an example of a portable terminal.

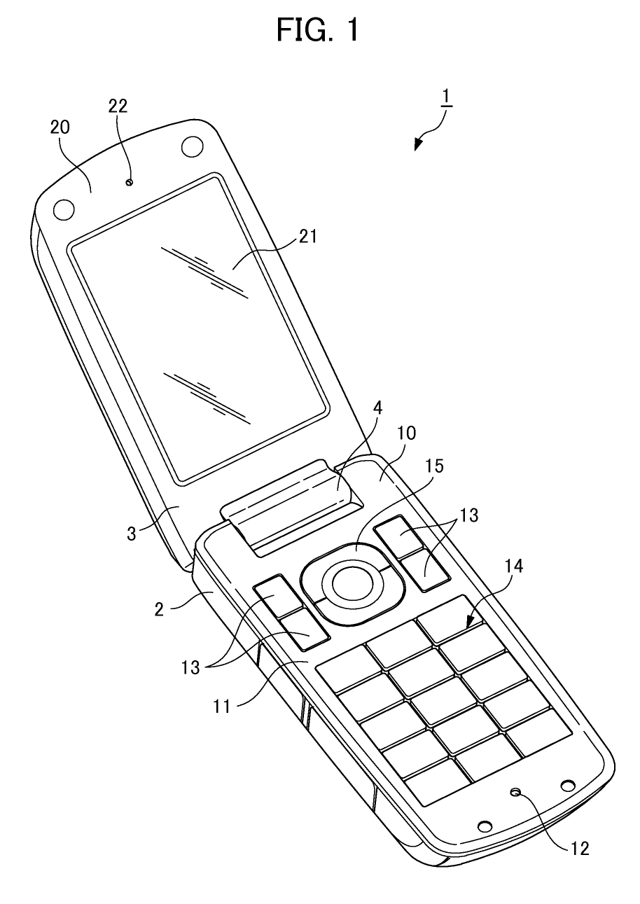

FIG. 1 is a perspective view showing an appearance of the PHS terminal 1 according to the present embodiment.

The PHS terminal 1 is configured to include an operation unit side body 2 and a display unit side body 3. The operation unit side body 2 is configured to include, on a front face portion 10 thereof, an operation unit 11 and a microphone 12 to which sound produced by a user of the PHS terminal 1 is input when the user is making a phone call or using a speech recognition application. The operation unit 11 is configured with: function setting operation buttons 13 for operating various functions such as for various setting functions, a telephone number directory function and a mail function; input operation buttons 14 for inputting the digits of a telephone number and characters for mail, etc.; and a selection operation button 15 for performing selection of various operations, scrolling, etc.

The display unit side body 3 is configured to include, on a front face portion 20, a display unit 21 for displaying a variety of information, and a receiver 22 for outputting sound of the other party of the conversation.

An upper end portion of the operation unit side body 2 and a lower end portion of the display unit side body 3 are connected via a hinge mechanism 4. The PHS terminal 1 can be in a state where the operation unit side body 2 and the display unit side body 3 are apart from each other (opened state), and in a state where the operation unit side body 2 and the display unit side body 3 are contacting each other (folded state), as the operation unit side body 2 and the display unit side body 3, connected via the hinge mechanism 4, pivot with respect to each other.

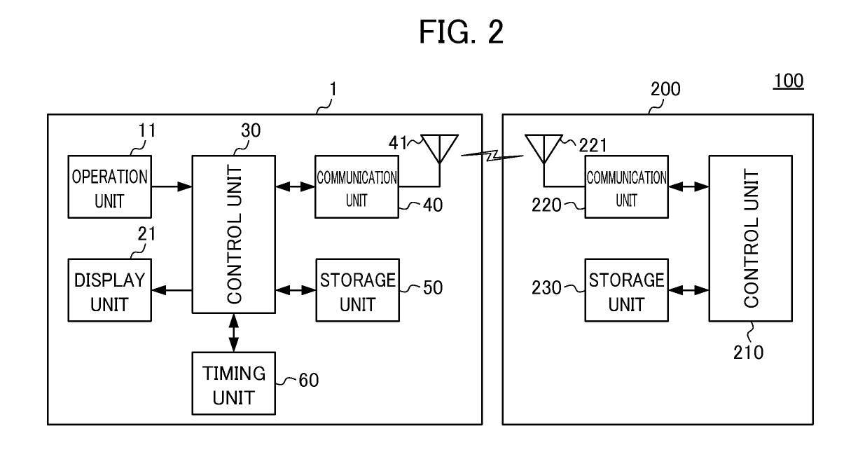

FIG. 2 is a block diagram showing functions of a wireless communication system 100 according to the present embodiment. The wireless communication system 100 is a system, in which the PHS terminal 1 wirelessly communicates with a base station 200 capable of controlling directional characteristic of radio waves to be transmitted toward a particular direction.

The PHS terminal 1 includes the operation unit 11, the display unit 21, a control unit 30, a communication unit 40, an antenna 41, a storage unit 50, and a timing unit 60. The base station 200 includes a control unit 210, a communication unit 220 an antenna 221, and a storage unit 230.

First of all, descriptions are provided for operations of the base station 200.

The control unit 210 controls the entirety of the base station 200, and controls wireless communication connection with the PHS terminal 1 through the communication unit 220. In doing so, the control unit 210 controls the storage unit 230 to read various programs and data, and to write data. For example, the storage unit 230 stores identification information of the PHS terminal 1, of which location has been registered.

The communication unit 220 transmits a signal in a control channel (CCH) via the antenna 221 in a slot cycle (at a first time interval: 100 msec) in a logical control channel (LCCH) super frame configuration, in accordance with control by the control unit 210. The communication unit 220 transmits a broadcasting signal (BCCH) including information for location registration, information about a channel structure, and system information, in the CCH of a head slot of the frame, i.e. in a maximum battery saving cycle (at a second time interval: 1200 msec).

In a case in which the communication unit 220 receives a request signal for establishing a link channel (LCH) from the PHS terminal 1, the control unit 210 causes the communication unit 220 to transmit an LCH assignment signal for assigning LCH to the PHS terminal 1 in the CCH. At this point in time, since the LCH assignment signal cannot be transmitted simultaneously with the BCCH that is given the top priority in the CCH, the control unit 210 transmits the LCH assignment signal to the PHS terminal 1 at timing different from the timing of transmitting the BCCH.

Here, the antenna 221 is an antenna of the adaptive array scheme as described above, and is capable of giving directional characteristics to radio waves to be transmitted in accordance with the control by the control unit 210. More specifically, the control unit 210 directs the antenna 221 toward a direction in which the LCH establishment request signal was received, and transmits an LCH assignment signal to the PHS terminal 1.

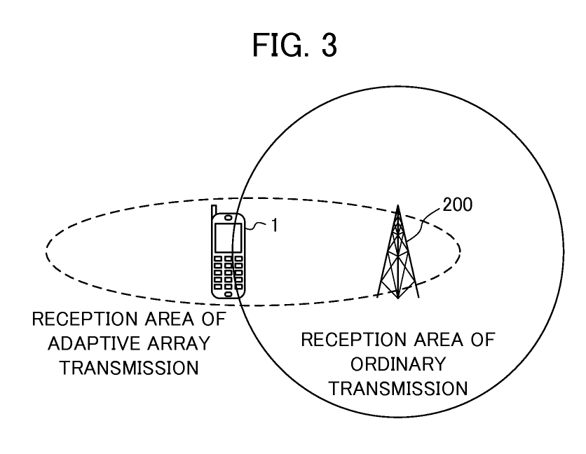

FIG. 3 is a conceptual diagram showing a reception area of radio waves transmitted from the antenna 221 according to the present embodiment.

In a case of ordinary transmission that does not give directional characteristics to radio waves to be transmitted from the base station, the reception area extends equally in all directions; on the other hand, in a case of adaptive array transmission that gives directional characteristics to radio waves to be transmitted from the base station, the reception area is extended further toward the direction of the PHS terminal 1 and is reduced in other directions.

The control unit 210 simultaneously transmits a BCCH or the like to an unspecified number of terminals in the neighboring area through ordinary transmission; on the other hand, the control unit 210 transmits an LCH assignment signal through adaptive array transmission in a case in which the location of the PHS terminal 1 is identified, since the LCH assignment signal is a signal directed to a particular PHS terminal 1.

However, in a case in which the timing of transmitting the LCH assignment signal is delayed due to overlapping with the timing of transmitting the BCCH, and if the PHS terminal 1 is moving, it is highly possible that the signal transmitted through the adaptive array may not be received. Therefore, the control unit 210 transmits the LCH assignment signal thus delayed, through ordinary transmission. In this case, the success rate in receiving the LCH assignment signal is reduced in the PHS terminal 1, as compared with a case of adaptive array transmission without such delay.

Next, descriptions are provided for operations of the PHS terminal 1.

The control unit 30 controls the entirety of the PHS terminal 1, and executes, for example, predetermined control of each unit such as the display unit 21 and the communication unit 40. The control unit 30 accepts inputs from the operation unit 11 and the like to execute a variety of processing. When executing such processing, the control unit 30 controls the storage unit 50 to read various programs and data, and to write data.

The communication unit 40 communicates with an external device (the base station 200) in a predetermined usable frequency band (for example, 1.9 GHz band). The communication unit 40 executes demodulation processing on a signal received via the antenna 41, and provides the signal thus processed to the control unit 30; the communication unit 40 executes modulation processing on a signal provided from the control unit 30, and transmits the signal to the external device via the antenna 41.

In the present embodiment, the communication unit 40 receives a CCH signal transmitted from the base station 200 at the first time interval (100 msec) as described above, and supplies the signal to the control unit 30.

When initiating location registration processing with the base station 200, outgoing call processing, or incoming call processing, the control unit 30 transmits an LCH establishment request signal to the base station 200 through the communication unit 40, in order to establish LCH with the base station 200. The control unit 30 establishes LCH by receiving an LCH assignment signal in the CCH from the base station 200.

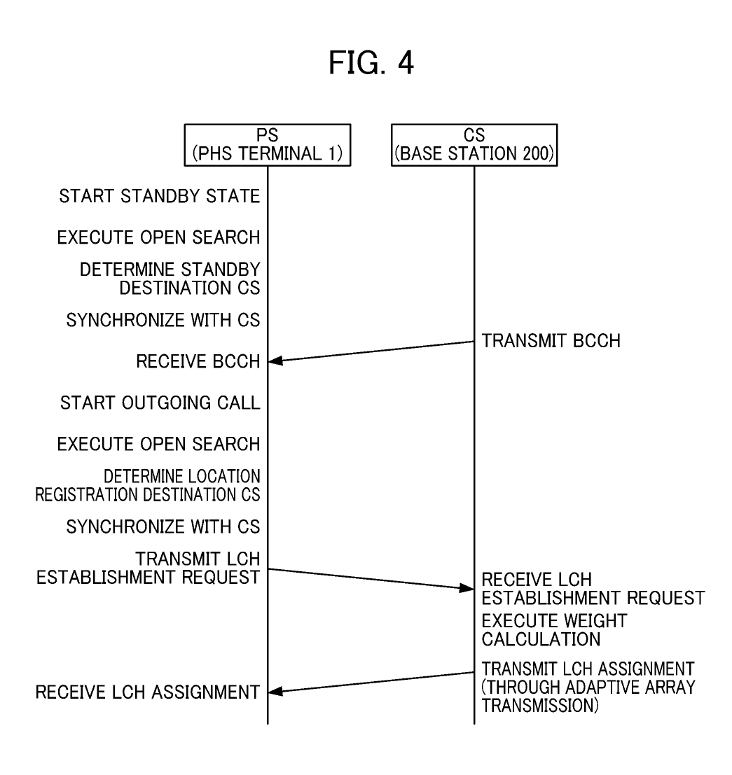

FIG. 4 is a sequence chart showing a first processing pattern of the wireless communication system 100 according to the present embodiment.

In a case in which the PHS terminal 1 (PS) initiates standby processing, the PHS terminal 1 searches (by open search) for a neighboring base station, determines a standby destination base station, and then is synchronized with the base station thus determined.

Subsequently, in a case in which the PHS terminal 1 initiates outgoing call processing, the PHS terminal 1 searches for a neighboring base station again, determines a base station 200 (CS) as a location registration destination, and then is synchronized with the base station 200 thus determined.

Subsequently, the PHS terminal 1 transmits an LCH establishment request signal to the base station 200. When the base station 200 receives the LCH establishment request signal, the base station 200 executes weight calculation for adaptive array, in order to give directional characteristics to radio waves to be transmitted toward the direction of the PHS terminal 1, based on radio waves thus received. In the next timing of transmitting a CCH signal, the base station 200 transmits the LCH assignment signal through adaptive array transmission.

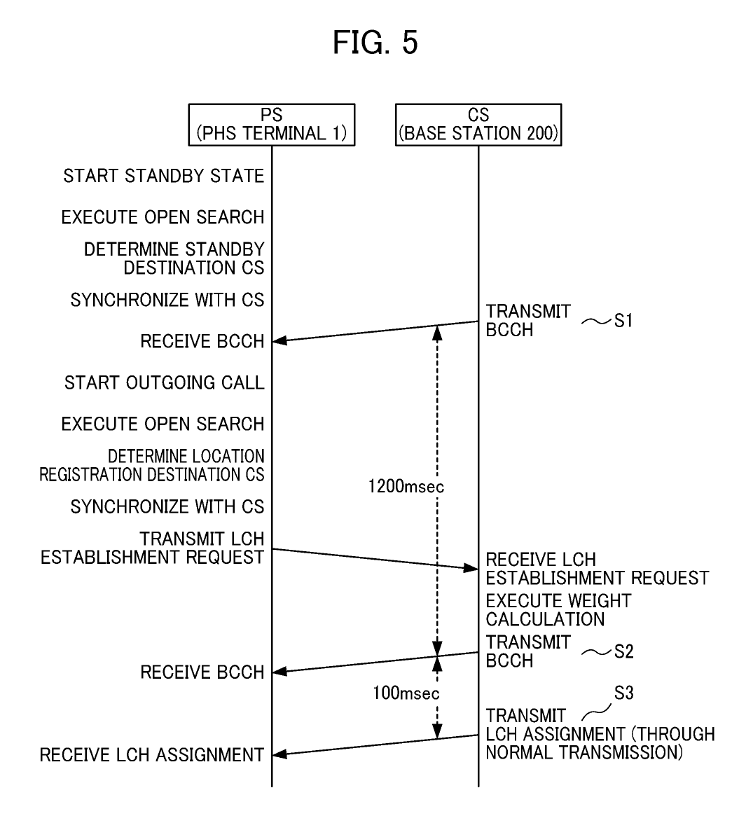

FIG. 5 is a sequence chart showing a second processing pattern of the wireless communication system 100 according to the present embodiment.

In this processing pattern, after the base station 200 receives the LCH establishment request signal, the next timing of transmitting a CCH signal coincides with timing of transmitting BCCH.

The timing of transmitting the CCH after (97.5 msec after) receiving the LCH establishment request signal by the base station 200 is at the second time interval (1200 msec) after the timing (S1) of previously transmitting BCCH, and is the timing of transmitting the BCCH. Therefore, the base station 200 transmits BCCH with priority (S2), and in further next timing of transmitting CCH, i.e. after the first time interval (100 msec) has elapsed, the base station 200 transmits an LCH assignment signal through ordinary transmission (S3) instead of adaptive array transmission.

With reference to FIG. 2 again, the storage unit 50 includes, for example, working memory, and is utilized for arithmetic processing by the control unit 30. The storage unit 50 stores various programs and the like according to the present embodiment. The storage unit 50 stores ID for identifying a current standby destination base station.

The timing unit 60 uses a watchdog timer to measure a time period elapsed since receiving BCCH from the base station 200 in CCH. The watchdog timer monitors the cycle of the LCCH super frame, and when a timeout occurs after the second time interval (1200 msec) as one cycle after measuring the time, the watchdog timer restarts timing the next one cycle.

Here, in order to prevent transmission of the LCH assignment signal in the second processing pattern (FIG. 5) from being changed from adaptive array transmission to ordinary transmission, the control unit 30 of the PHS terminal 1 performs operations as follows.

In a case in which the control unit 30 establishes LCH with the base station 200, the control unit 30 causes the communication unit 40 to transmit an LCH establishment request signal to the base station 200 after a third time interval (2.5 msec) has elapsed since receiving the CCH signal by the communication unit 40.

At this point in time, by referring to a time period elapsed thus measured by the timing unit 60, the control unit 30 controls the timing of transmitting an LCH establishment request signal, such that the timing of transmitting the next BCCH by the base station 200 does not coincide with the timing of transmitting an LCH assignment signal.

More specifically, in a case in which the timing of transmitting the LCH establishment request signal is immediately before (97.5 msec before) the timing of receiving the next BCCH, the control unit 30 transmits the LCH establishment request signal with delay of the first time interval (100 msec), such that the timing of transmitting the BCCH by the base station 200 does not coincide with the timing of transmitting the LCH assignment signal. The control unit 30 may transmit an LCH establishment request signal when the first time interval (100 msec) elapsed since the original timing of transmission, or may transmit an LCH establishment request signal when the third time interval (2.5 msec) elapsed since receiving the next BCCH.

As a result, the base station 200 can transmit an LCH assignment signal without delay. Therefore, the communication unit 40 of the PHS terminal 1 can receive an LCH assignment signal through adaptive array transmission with accuracy higher than that of ordinary transmission.

In some cases, the ID of the base station 200 to which the LCH establishment request signal is transmitted may be different from the ID of the standby destination base station stored in the storage unit 50. In this case, since the timing may not coincide with the timing of transmitting BCCH as measured by the timing unit 60, the control unit 30 does not execute the processing of delaying transmitting an LCH establishment request signal.

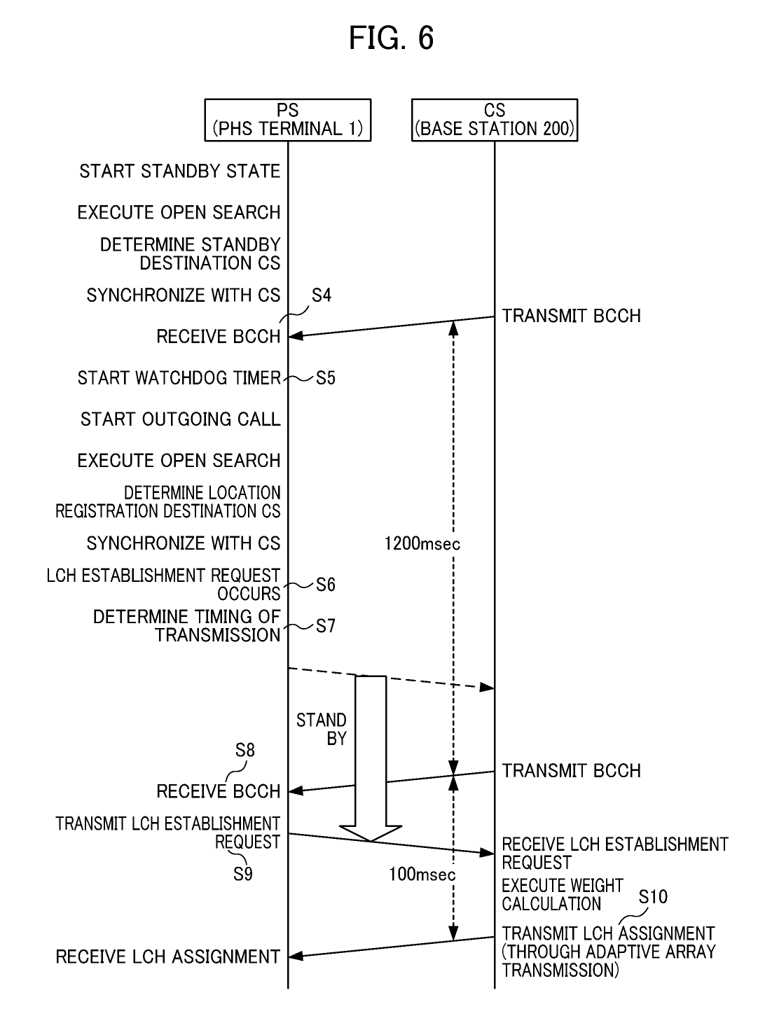

FIG. 6 is a sequence chart showing a third processing pattern of the wireless communication system 100 according to the present embodiment.

In the present processing pattern, the standby destination base station 200 is identical with the base station 200 as the location registration destination through an outgoing call.

After the PHS terminal 1 determines the standby destination base station 200, and in response to receiving BCCH from the base station 200 (S4), the PHS terminal 1 controls the timing unit 60 to start the watchdog timer (S5).

Subsequently, when an LCH establishment request occurs (S6), the PHS terminal 1 determines the timing of transmitting an LCH establishment request signal.

When the LCH establishment request occurs, the PHS terminal 1 transmits the LCH establishment request signal after the third time interval (2.5 msec) has elapsed since receiving the next CCH. Therefore, in a case in which the LCH establishment request occurs between “1000 msec” and “1100 msec” after receiving the previous BCCH (S4), the timing of transmitting the LCH establishment request signal is “1100 msec +2.5 msec” thereafter; as a result, the timing of transmitting the LCH assignment signal overlaps with the timing of transmitting the BCCH.

Accordingly, after the standby for the first time interval (100 msec), the PHS terminal 1 receives BCCH (S8), and then transmits an LCH establishment request signal (S9). When the base station 200 receives the LCH establishment request signal, the base station 200 executes weight calculation for adaptive array. In the next timing of transmitting a CCH signal, the base station 200 transmits the LCH assignment signal through adaptive array transmission (S10).

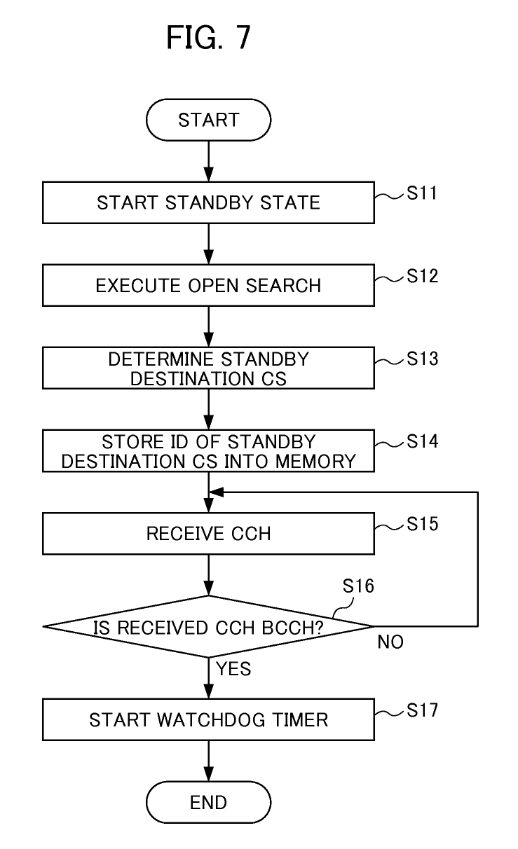

FIG. 7 is a flowchart showing processing until starting the watchdog timer in the PHS terminal 1 according to the present embodiment.

In Step S11, the control unit 30 initiates the standby processing.

In Step S12, the control unit 30 searches (by open search) for a neighboring base station as a standby destination.

In Step S13, the control unit 30 determines a standby destination base station (CS), based on a predetermined rule such as selecting a base station with the strongest field intensity, as a result of the processing in Step S12.

In Step S14, the control unit 30 stores, into the storage unit 50, identification information (ID) of the standby destination base station that is determined in Step S13.

In Step S15, the control unit 30 receives CCH from the standby destination base station.

In Step S16, the control unit 30 determines whether the CCH signal received in Step S15 is BCCH. In a case in which the determination is YES, the control unit 30 advances the processing to Step S17, and in a case in which the determination is NO, the control unit 30 returns the processing to Step S15.

In Step S17, since BCCH is received from the standby destination base station, the control unit 30 controls the timing unit 60 to start the watchdog timer.

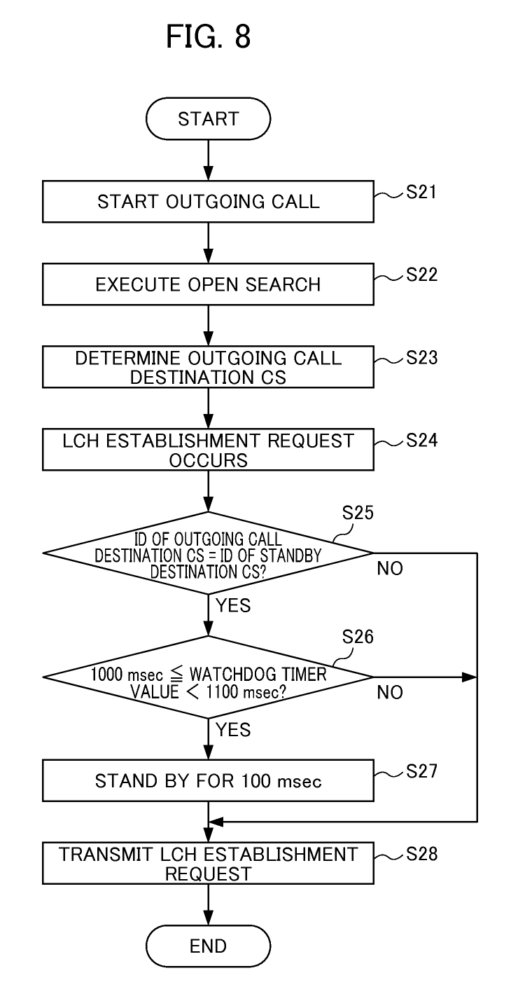

FIG. 8 is a flowchart showing processing of establishing LCH in response to an outgoing call event, in the PHS terminal 1 according to the present embodiment.

In Step S21, the control unit 30 initiates outgoing call processing in response to an outgoing call event.

In Step S22, the control unit 30 searches (by open search) for a neighboring base station as an outgoing call destination.

In Step S23, the control unit 30 determines an outgoing call destination base station (CS), based on a predetermined rule such as selecting a base station with the strongest field intensity, as a result of the processing in Step S22.

In Step S24, the control unit 30 initiates the processing of establishing LCH, which results in occurrence of an LCH establishment request to the outgoing call destination base station.

In Step S25, the control unit determines whether the ID of the outgoing call destination base station coincides with the ID of the standby destination base station stored in the storage unit 50. In a case in which the determination is YES, the control unit 30 advances the processing to Step S26, and in a case in which the determination is NO, the control unit 30 advances the processing to Step S28.

In Step S26, the control unit 30 determines whether the value of the watchdog timer started in the processing shown in FIG. 7 is at least “1000 msec” and under “1100 msec”. In a case in which the determination is YES, the control unit 30 advances the processing to Step S27, and in a case in which the determination is NO, the control unit 30 advances the processing to Step S28.

In Step S27, the control unit 30 stands by for the first time interval (100 msec), such that the outgoing call destination base station transmits an LCH assignment signal without delay.

In Step S28, after the third time interval (2.5 msec) has elapsed since receiving the next CCH from the outgoing call destination base station, the control unit 30 transmits an LCH establishment request signal to the outgoing call destination base station.

As described above, according to the present embodiment, the PHS terminal 1 can adjust the timing of transmitting an LCH establishment request signal, thus can prevent delay in the LCH assignment signal transmitted by the base station 200, and can prevent adaptive array transmission from being changed to ordinary transmission. Therefore, with PHS terminal 1, the success rate in receiving an LCH assignment signal can be improved.

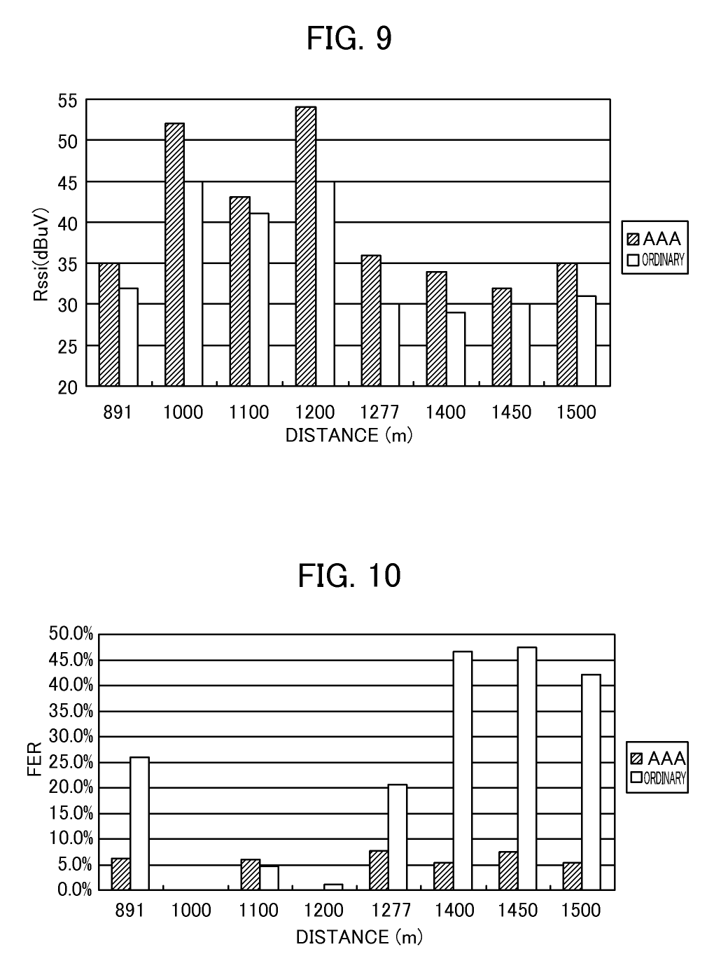

FIG. 9 is a diagram showing a relationship between the distance from the base station 200 and the field intensity of receiving an LCH assignment signal (Rssi) by the PHS terminal 1.

The average reception Rssi is “43.4 dBuV” in a case of adaptive array transmission (AAA), which is more than “5 dBuV” higher than the average reception Rssi “38.0 dBuV” in a case of ordinary transmission.

When the reception Rssi of an LCH assignment signal is improved, the success rate in establishing LCH is improved, and the success rate in communication is also improved.

FIG. 10 is a diagram showing a relationship between the distance from the base station 200 and the error rates in receiving an LCH assignment signal by the PHS terminal 1.

In a case of ordinary transmission, there is a tendency that the reception error rate is increased as the distance from the base station 200 is increased. On the other hand, in a case of adaptive array transmission (AAA), the reception error rate is maintained at a lower value even if the distance from the base station 200 is increased, as compared with the case of ordinary transmission. In other words, since the adaptive array transmission expands the communication area, the success rate in establishing LCH is improved, and the success rate in communication is also improved.

Although the preferable embodiment has been described above, the present invention is not limited to the aforementioned embodiment, and can be implemented as various embodiments. The effects described in the embodiment merely exemplify the most preferable effects arising from the present invention, and the effects according to the present invention are not limited to those described above.

The portable terminal according to the present invention is not limited to the PHS terminal 1. In other words, the present invention is not limited to communication protocols for PHS, but in a case in which the priority of a signal transmitted from the other party in wireless communication through adaptive array is lower than the priority of other signals transmitted in a constant cycle, the present invention can be applied to such a case in which the signal with the lower priority is required.

### INDUSTRIAL APPLICABILITY

According to the present invention, the success rate in receiving an assignment signal for a link channel can be improved, and the present invention is useful for a portable terminal, a wireless communication system and the like, which wirelessly communicate with a base station capable of controlling directional characteristics of radio waves to be transmitted.

### EXPLANATION OF REFERENCE NUMERALS

1 PHS terminal (portable terminal)
11 operation unit
21 display unit
30 control unit
40 communication unit
41 antenna
50 storage unit
60 timing unit
100 wireless communication system
200 base station
210 control unit
220 communication unit
221 antenna
230 storage unit

1. A portable terminal, comprising:
a communication unit that wirelessly communicates with a base station capable of controlling directional characteristics of radio waves to be transmitted toward a particular direction, and receives a signal in a control channel transmitted from the base station at a first time interval;
a timing unit that measures a time period elapsed since receiving a broadcasting signal transmitted from the base station in the control channel at a second time interval; and
a control unit, wherein, in a case in which a link channel is established with the base station, after the communication unit receives a signal in the control channel, the control unit causes the communication unit to transmit a request signal to the base station, and causes the communication unit to receive an assignment signal for assigning the link channel in the control channel, the assignment signal being transmitted from the base station in response to the request signal, and
wherein the control unit controls timing of transmitting the request signal, such that timing of transmitting a next broadcasting signal by the base station does not coincide with timing of transmitting an assignment signal.

2. The portable terminal according to claim 1, wherein the control unit refers to the time period elapsed thus measured by the timing unit, and in a case in which the timing of transmitting the request signal is immediately before the timing of transmitting the next broadcasting signal by the base station, the control unit transmits the request signal with delay.

3. The portable terminal according to claim 2, wherein the control unit transmits the request signal with delay of the first time interval.

4. The portable terminal according to claim 2, wherein the control unit transmits the request signal after a third time interval has elapsed since receiving the next broadcasting signal.

5. The portable terminal according to claim 1, wherein the assignment signal is a signal, of which priority of transmitting is lower than priority of transmitting the broadcasting signal.

6. A wireless communication system, in which a portable terminal wirelessly communicates with a base station capable of controlling directional characteristic of radio waves to be transmitted toward a particular direction,
the base station comprising:
a base station communication unit that transmits a signal in a control channel at a first time interval, and transmits a broadcasting signal in the control channel at a second time interval; and
a base station control unit, wherein, in a case in which a request signal for establishing a link channel is received from the portable terminal, the base station control unit directs directional characteristics of radio waves to be transmitted toward a direction in which the request signal is received, and causes the base station communication unit to transmit an assignment signal for assigning the link channel, to the portable terminal in the control channel at timing different from timing of transmitting the broadcasting signal,
the portable terminal comprising:
a terminal communication unit that receives a signal in the control channel;
a timing unit that measures a time period elapsed since receiving the broadcasting signal; and
a terminal control unit, wherein, in a case in which the link channel is established with the base station, the terminal control unit causes the terminal communication unit to transmit the request signal to the base station after a third time period has elapsed since receiving a signal in the control channel, and causes the terminal communication unit to receive the assignment signal in the control channel transmitted from the base station,
wherein the terminal control unit refers to the time period elapsed thus measured by the timing unit, and controls timing of transmitting the request signal, such that timing of transmitting a next broadcasting signal by the base station does not coincide with the timing of transmitting the assignment signal.

7. A wireless communication method, in which a base station wirelessly communicates with a portable terminal, the base station being capable of controlling directional characteristic of radio waves to be transmitted toward a particular direction, the base station including a base station communication unit that transmits a signal in a control channel at a first time interval, and transmits a broadcasting signal in the control channel at a second time interval, the portable terminal including a terminal communication unit that receives a signal in the control channel, the method comprising:
a requesting step for the terminal communication unit to transmit a request signal to the base station after a third time period has elapsed since receiving a signal in the control channel, in a case in which the portable terminal establishes a link channel with the base station; and
an assigning step for the base station to direct directional characteristics of radio waves to be transmitted toward a direction in which the request signal is received, and to cause the base station communication unit to transmit an assignment signal for assigning the link channel, to the portable terminal in the control channel at timing different from timing of transmitting the broadcasting signal, in a case in which the base station receives the request signal,
wherein, in the requesting step, the portable terminal refers to a time period elapsed measured in a timing step, and controls timing of transmitting the request signal, such that timing of transmitting a next broadcasting signal by the base station does not coincide with the timing of transmitting the assignment signal.
